(19) United States
(12) Patent Application Publication
(10) Pub. No.: US 2024/0292809 A1
(43) Pub. Date: Sep. 5, 2024

(54) Livestock Headgate with Back-Out Prevention Capability for Wide-Necked Livestock

(71) Applicant: Northquip Inc., Woodlands (CA)

(72) Inventors: Philip Malcolm Firth, Woodlands (CA); Stephen Arthur Langrell, Woodlands (CA)

(21) Appl. No.: 18/571,413

(22) PCT Filed: Sep. 14, 2021
(86) PCT No.: PCT/CA2021/051279

§ 371 Date: Dec. 18, 2023

Related U.S. Application Data
(60) Provisional application No. 63/242,328, filed on Sep. 9, 2021.

(51) Int. Cl. A01K 1/06

(52) U.S. Cl. CPC A01K 1/0613

(57) ABSTRACT

A livestock headgate has a pair of gate panels movable between closed and open positions holding an releasing an animal in an exit opening of a livestock chute. Each gate panel, at the inner edge thereof facing the other gate panel, has a respective angled bracing surface for abutting against a respective lateral side of a neck of the livestock animal in the gate's closed position. In a forward direction moving toward a front of the gate that faces outward from the chute, the angled bracing surfaces are of convergent relation to one another, and thus closer together near the animal's head and further apart from one another closer to the animal's shoulders. The angled bracing surfaces help prevent back-out of wide-necked animals from the closed gate, and may be embodied as auxiliary bracing members of an optional add-on kit for a standard head gate.

### FIELD OF THE INVENTION

The present invention relates generally to livestock headgates of the type used at an exit of a livestock chute for the purpose of securing an animal at said exit.

### BACKGROUND

Headgates of the forgoing type are commonly used on livestock squeeze chutes, and typically feature a pair of gate panels that are movable toward one another into a closed position bracing a livestock animal between said gate panels in a central opening therebetween, and movable away from one another into an open position releasing the animal from the central opening. In the closed position, the two gate panels abut against opposing sides of the animal's neck in a manner blocking forward movement of the animal's shoulders, whereby the animal's head resides in accessible fashion outside the chute at the front side of the gate, while the animal's shoulders, torso and limbs remain contained inside the chute behind the headgate, typically in a stabilized fashion held between two movable squeeze panels of the chute. The animal is thus held relatively still for safe inspection or treatment thereof.

A typical headgate employs metal tubing for the structural framework of each gate panel, whereby the inner edge of each gate panel that abuts against the animal in the closed position is often formed by an upright length of such metal tubing, whether round or rectangular (e.g. square) in cross section depending on the design of the headgate.

A particular problem that can arise in use of these headgates occurs when working with large bulls, whose anatomical structure can often be of greater lateral width at the neck then at the head. Because the gate panels of the headgate contact the animal at the lateral sides of the neck, the result is that the open space between the two gate panels in their closed position is greater in width than the animal's head, which creates the risk that by pulling backward, the large bull can back out itself out of the closed headgate.

Accordingly, there is a need for a headgate modification that can alleviate this shortcoming of conventional headgate designs when it comes to handling of bulls or other large-necked animals.

### SUMMARY OF THE INVENTION

According to one aspect of the invention, there is provided a livestock headgate comprising:
a pair of gate panels movably supported in a manner movable toward one another into a closed position bracing a livestock animal between said gate panels in a central opening therebetween, and movable away from one another into an open position releasing said livestock animal from said central opening between said gate panels;
wherein:
each gate panel has a front side, a rear side facing oppositely of said frontside, and an inner edge that is of neighbouring relation to the central opening and faces toward the inner edge of the other gate panel;
each gate panel, at the inner edge thereof, has a respective angled bracing surface for abutting against a respective lateral side of a neck of the livestock animal in said closed position of the gate panels; and
in a forward direction moving toward the front sides of the gate panels from the rear sides thereof, said angled bracing surfaces are of convergent relation to one another so as to be closer together at forward regions thereof nearest a head of the animal and further apart at rearward regions thereof further away from the head of the animal and nearer to shoulders thereof.

According to another aspect of the invention, there is provided an accessory for a livestock headgate that comprises a pair of gate panels that are movable toward one another into a closed position bracing a livestock animal between said gate panels in a central opening therebetween, are movable away from one another into an open position releasing said livestock animal from said central opening between said gate panels, and each have a front side, a rear side facing oppositely of said frontside, and an inner edge that is of neighbouring relation to the central opening and faces toward the inner edge of the other gate panel, said accessory comprising:
a pair of auxiliary bracing members each configured for removable attachment to a respective one of the gate panels at the inner edge thereof, and each comprising a respective angled bracing surface for abutting against a respective lateral side of a neck of the livestock animal in said closed position of the gate panels, said auxiliary bracing members being shaped such that, when mounted on the gate panels at the inner edges thereof, the angled bracing surfaces reside in convergent relation to one another in a forward direction moving toward the front sides of the gate panels from the rear sides thereof, so that said angled bracing surfaces are closer together at forward regions thereof nearest a head of the animal and further apart at rearward regions thereof further away from the head of the animal and nearer to shoulders thereof.

### BRIEF DESCRIPTION OF THE DRAWINGS

One embodiment of the invention will now be described in conjunction with the accompanying drawings in which:

FIG. 1 is a front perspective view of a squeeze chute having an unmodified headgate of the prior art.

FIG. 2 is a front perspective view of a modified headgate of the present invention having a pair of auxiliary bracing bars installed thereon for improved back-out prevention with wide-necked animals.

FIG. 3 is a cross-sectional view of the headgate of FIG. 3 as viewed along line A-A thereof.

FIG. 4 is an isolated perspective view of the auxiliary bracing bars.

FIG. 5 is a top plan view of the auxiliary bracing bars.

FIG. 6 is a front elevational view of the auxiliary bracing bars.

FIG. 7 is a rear elevational view of the auxiliary bracing bars.

### DETAILED DESCRIPTION

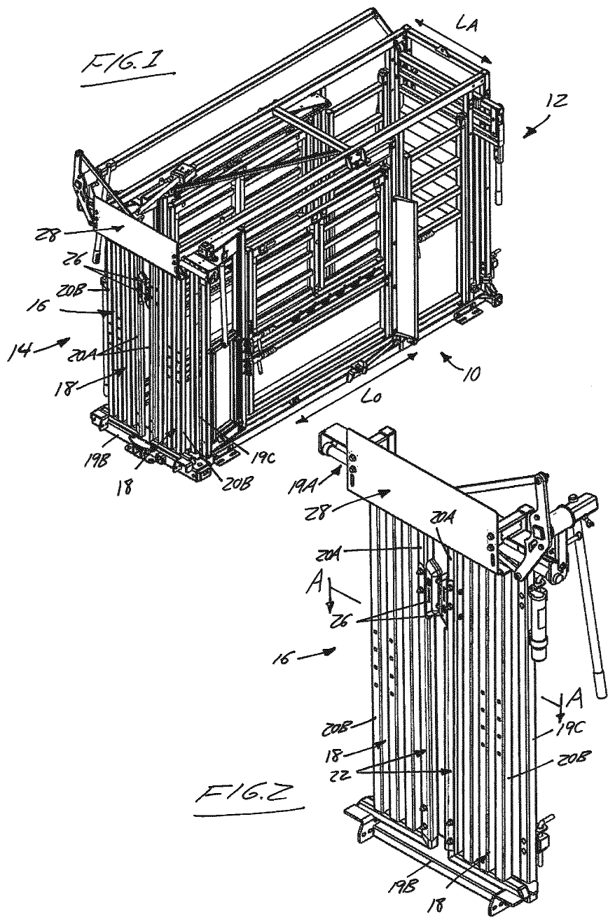

For the purpose of setting the context of the present invention, FIG. 1 shows a livestock squeeze chute 10 having a rear entrance end 12 and a front exit end 14 that reside opposite of one another in a longitudinal direction L_{O} in which the chute is elongated. In use of the chute, cattle travel forwardly therethrough in the longitudinal direction from the rear entrance end 12 to the front exit end 14. In typical fashion, a headgate 16 is installed at the front exit end 14 of the chute 10. The headgate 16 comprises two gate panels 18 that are each displaceable back and forth in a lateral direction L_{A} of perpendicularly transverse relation to the longitudinal direction. In the illustrated style of headgate, each gate panel 18 is movably supported a respective roller carriage that is attached to the top end of the gate panel 18, and thus is able to roll back and forth along a horizontal guide track 19A that spans across a top end of the chute's exit opening. A remaining three sides of the chute's exit opening which are delimited by a horizontal base 19B situated vertically opposite of the guide track 19A in elevated and parallel relation thereto, and a pair of upright frame members 19C that span vertically between the base 19B and elevated guide track 19A at opposite sides of the exit opening.

Each gate panel 18 in the illustrated embodiment has an uncladded structural assembly composed of a plurality of vertically upright bars residing side-by-side in a shared vertical plane of lateral orientation. The bars of these uncladded gate panels reside at horizontally spaced intervals from one another, thus leaving vertically elongated slot-shaped openings between the adjacent bars 78. These bars include an inside bar 20A that resides nearest a vertically oriented longitudinal midplane P_{M} of the chute, and an outside bar 20B that resides furthest from the longitudinal midplane P_{M} of the chute in opposing relation to the inside bar 20A. The uncladded skeletal structure of each gate panel of the illustrated embodiment further includes additional upright bars 20C, 20D residing between the inside and outside bars in intermediate relation thereto, though other embodiments may lack such intermediate upright bars, for example in favour of solid cladding filling the open space between the inside and outside bars of the panel's structural assembly. As will be appreciated form the following description, the particular structural style of the gate panels is not critical to the operation or purpose of the present invention, namely the prevention or mitigation of the back-out problem particularly associated with large-necked animals, as outlined herein above.

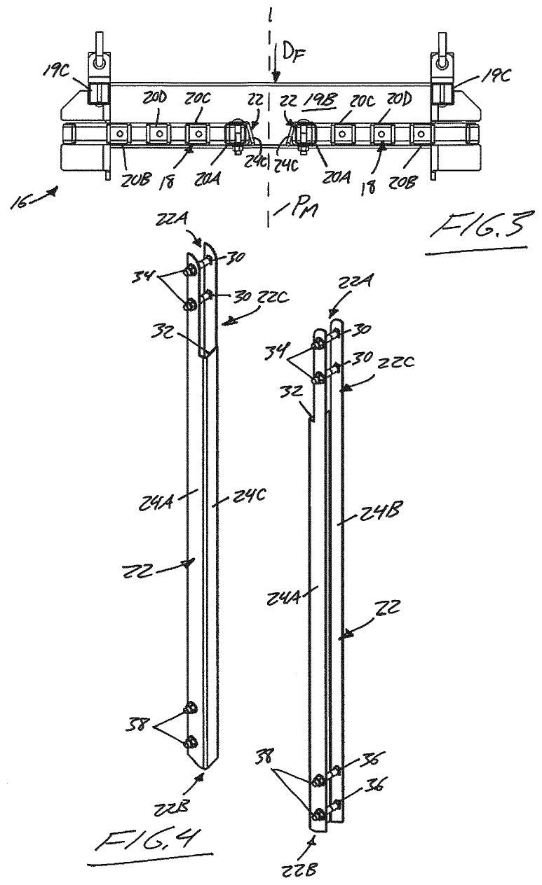

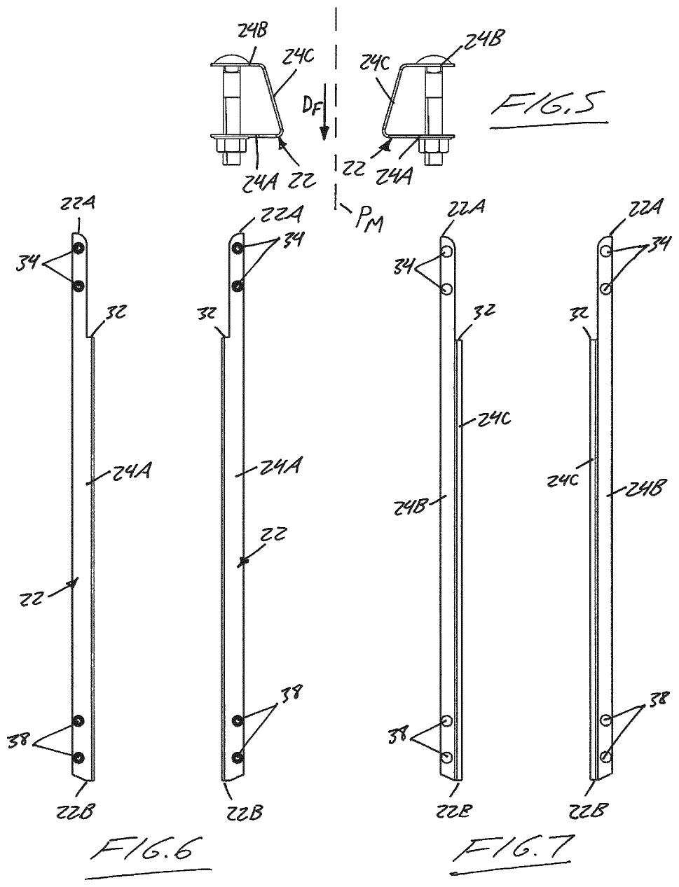

Turning to FIGS. 2 and 3, the illustrated embodiment addresses the headgate back-out problem through respective installation of a pair of auxiliary bracing members 22 onto the inside bars 20A of the two headgate panels 18. By addressing the problem through an auxiliary add-on, a manufacturer of the chute can offer the auxiliary bracing members 22 as an optional add-on for customers with a particular need to address the back-out problem of large-necked animals, while selling a standard chute with the unmodified headgate of FIG. 1 to other customers who don't necessarily require the add-on. Additionally, the auxiliary bracing members 22 can be similarly be retrofitted onto existing chutes of previous customers. That being said, it will also be appreciated that the functional features of the auxiliary bracing members 22, described in more detail below, can optionally be built-into newly constructed headgates as permanently integral features thereof, rather than being implemented through selective installation of a separate add-on kit.

Each auxiliary bracing member 22 in the illustrated embodiment is composed of a singular length of metal channel whose direction of elongation is oriented vertically upright in the bracing member's installed position on the inside bar 20A of the respective gate panel 18 of the headgate 16. Accordingly, opposing ends of each bracing member are referred to herein as top and bottom ends 22A, 22B of the bracing member 22. A vertical length of each bracing member 22, as measured between the opposing top and bottom ends 22A, 22B thereof is less than the vertical length of the inside bars 20A of the gate panels 18, the latter of which is also referred to herein simply as the inside height of the gate panel. The vertical length of each bracing member 22 preferably spans at least half, and more preferably at least two-thirds, of the inside height of the gate panel, thus spanning a majority height of the gate panel at the inside edge thereof nearest to the other gate panel.

When the bracing members are cross-sectioned in horizontal reference planes of perpendicular relation to their vertical lengths, each bracing member 22 has a channel-shaped cross-section over most of its length, with the exception of an upper cutout region 22C of each bracing member. Over the channel-shaped majority of its length, the cross-section of each bracing member 22 is generally U-shaped, with two side walls 24A, 24B and a central wall 24C spanning therebetween. However, instead of a conventional right-angle channel composed of two identical side walls of equal width and a central wall spanning perpendicularly between the two side walls, the channel-shaped cross section is an irregularly angled channel composed of a wider side wall 24A, a narrower side wall 24B of lesser width than said wider side wall 24A, and an angled central wall 24C of obliquely angled relationship to the two parallel and opposing side walls 24A, 24B. In each bracing member's installed position on the inside bar 20A of the respective gate panel 18, the wider side wall 24A of the bracing member 22 resides in parallel adjacency to a front face of the inside bar 20A at a front side of the gate panel 18 that faces outwardly from the chute's interior, while the narrower side wall 24B of the bracing member 22 resides in parallel adjacency to a rear face of the inside bar 20A at an opposing rear side of the gate panel 18 that faces into the chute's interior. The angled central wall 24C of the bracing member thus spans across an inside face of the inside bar 20A of the gate panel that faces toward the inside bar of the other gate panel.

As best shown in FIG. 3, the angled central wall 24C thus resides in non-parallel relation to the adjacent inside face of the gate panel's inside bar 20A, and more specifically in an orientation that, in a horizontally forward direction DF moving from the rear side of the gate panel to the front side thereof, i.e. moving outwardly from the chute interior, angles inwardly toward from the midplane P_{M} that bisects the headgate 16 and chute 10. The two bracing members 22 are of mirrored symmetry to one another, whereby the central walls 24C of the two installed bracing members 22 are of convergent relationship to one another in the horizontally forward direction moving out from the chute interior. The surface of each bracing member's central wall 24C that faces toward the midplane P_{M} thus forms an auxiliary bracing surface of obliquely angled relation to the midplane P_{M} at the inside edge of the gate panel that resides nearest to the midplane and faces toward the other gate panel. With the bracing members installed, it is these auxiliary bracing surfaces that brace against the lateral side of an animal's neck in the closed position of the headgate 16, as opposed to the inside faces of the inside bars 20A that are oriented parallel to the midplane P_{M} and would otherwise brace against the animal's neck in the absence of the add-on bracing members 22.

The forwardly convergent relationship between the auxiliary bracing surfaces formed by obliquely oriented central walls 24C of the bracing members 22 has been found effective to better prevent backing out of large-necked bulls from the headgate, compared to the use of the inside faces of the inside bars as the neck-bracing surfaces of the headgate. The forwardly convergent central walls 24C of the bracing members are closest to one another at the rounded front corners of the bracing members, where the outside angle between the wider side wall 24A and the central wall 24C is greater than 90 degrees. The open space between the central walls 24C of the two bracing members is thus at its narrowest at the inside front corners of the modified headgate, i.e. at the part of the headgate nearest the animal's head, and then grows wider moving rearwardly toward the shoulders and torso of the animal. This forms a more effective “catch” for better resisting back-out of wide-necked bulls from between the two gate panels by better conforming with their anatomical shape whose neck-to-head width ratio is greater than other smaller-necked cattle. Accordingly, the add-on accessory kit of the illustrated embodiment may also be referred to as a “bull catcher”.

As mentioned above, each bracing member 22 of the illustrated embodiment features an upper cutout region 22C where the bracing member deviates from the channel-shape that is possessed over the majority of its height. The central wall 24C is cut out at this upper region 22C, leaving only the two side walls 24A, 24B, of which the side wall 24A installed at the front side of the gate panel, i.e. the wider side wall of the channel shaped majority of the bracing member, may be cut down to a reduced width matching the other side wall 24B. So, whereas the wider side wall 24A at the channel shaped majority of the bracing member is wider than the front face of the inside bar 20A of the gate panel 18 so as to project inwardly beyond the inside face of the inside bar at the front of the gate panel, this same side wall 24A need not have this excess projecting width at the upper region 22C of the bracing member, where this side wall 24A thus may be of more comparable or equivalent width to the front face of the gate panel's inside bar 20A.

The cut away absence of the central wall 24C at the upper region 22C leaves a fully open void space between the side walls 24A, 24B at this upper region. The purpose of these voids can be seen in FIG. 2, where a pair of yoke members 26 fastened to the inside faces of the inside bars 20A of the two gate panels 18 can be seen to project through these void spaces at the upper regions 22C of the two bracing members. The purpose of these yoke members 26 is to form an effective block to upward thrashing of the animal's neck in the closed position of the headgate, thus preventing the animal from making potentially harmful impact with overhead features of the gate or chute, such as the overhead guide track 19A and/or overhead signage 28 that may likewise resides overhead of the chute's exit opening.

In the illustrated embodiment, a set of upper fastening holes 30 penetrate through the two side walls 24A, 24B of each bracing member 22 at the upper cutout region 22c thereof. These fastening holes 30 align with a matching set of upper fastening holes that penetrate the front and rear faces of the inside bar 20A of the respective gate panel at an elevation above the bottom ends of the two yoke members 26. In the installed position of each bracing member 22, the truncated upper end 32 of the central wall 24C resides in abutted contact with, or at least close adjacency to, the bottom of the yoke member 26 of the respective gate panel. The side walls 24A, 24B of the bracing member extend upwardly past the bottom end of the yoke member 26 for bolted attachment of the side walls 24A, 24B to the inside bar 20A of the respective gate panel 18 at the front and rear sides thereof via a set of upper mounting bolts 34 fed through the aligned sets of upper fastening holes. This way, the upper mounting bolts 34 are elevated above the bottom ends of the yoke members 26 to ensure that the bolts are out of upward thrashing reach of the animal to prevent any potential harm thereto. The snug fit between the truncated top ends 32 of the cutout central walls 24C of the bracing members 22 and the bottom ends of the yoke members 26 prevents any exposed sharp edges or gaps that might otherwise might denote a cutting or snag hazard to the skin of a thrashing animal.

A set of lower fastening holes 36 likewise penetrate through the two side walls 24A, 24B of each bracing member 22 near the bottom end 22B thereof and align with a matching set of lower fastening holes that penetrate the front and rear faces of the inside bar 20A of the respective gate panel near the bottom end thereof. These sets of lower fastening holes are used for further fastening of the bracing members to the inside bars of the gate panels at the front and rear sides thereof via a set of lower mounting bolts 38 fed through the aligned sets of lower fastening holes.

In the illustrated embodiment, the yoke members 26 span the full width of the inside faces of the inside bars 20A of the gate panels 18, and so the entirety of the central wall 24C of each bracing member is removed at the cutout upper region 22C thereof, though in other embodiments, the central wall of each bracing member may have only a partial cutout therein at the upper cutout region to create a hole through which the yoke member is instead accommodated. Though the illustrated embodiment shows mounting of the auxiliary bracing members 22 in bolted, and thus removable, fashion, alternate means for removable mounting or permanent affixation (e.g. welding) may alternatively be employed.

As mentioned above, though there are benefits to implementing the invention via an add-add bull catcher kit like the illustrated embodiment, the invention may alternatively be implemented by building of the angled bracing surfaces directly into the structural assembly of the gate panel itself, for example replacing the rectangular inside bar 20A with a modified inside bar that is suitably oriented or shaped to place its inside face at the described oblique relation to the midplane so that the insides faces of the two inside bars are of forwardly convergent relation to one another to better resist the back-out of bulls or other wide-necked animals. Whether via integration into the gate panel structure, or by add-on of auxiliary bracing members, the same effective result of obliquely angled and forwardly convergent bracing surfaces at inside edges of the gate panels nearest to the midplane is achieved for effective catching of bulls and other such wide-necked animals.

Since various modifications can be made in my invention as herein above described, and many apparently widely different embodiments of same made, it is intended that all matter contained in the accompanying specification shall be interpreted as illustrative only and not in a limiting sense.

1. A livestock headgate comprising:
a pair of gate panels movably supported in a manner movable toward one another into a closed position bracing a livestock animal between said gate panels in a central opening therebetween, and movable away from one another into an open position releasing said livestock animal from said central opening between said gate panels; and
wherein:
each gate panel has a front side, a rear side facing oppositely of said frontside, and an inner edge that is of neighbouring relation to the central opening and faces toward the inner edge of the other gate panel;
each gate panel, at the inner edge thereof, has a respective angled bracing surface for abutting against a respective lateral side of a neck of the livestock animal in said closed position of the gate panels; and
in a forward direction moving toward the front sides of the gate panels from the rear sides thereof, said angled bracing surfaces are of convergent relation to one another so as to be closer together at forward regions thereof nearest a head of the animal and further apart at rearward regions thereof further away from the head of the animal and nearer to shoulders thereof.

2. The livestock headgate of claim 1 wherein each gate panel comprises a structural assembly, and the respective angled bracing surface is defined by a separate bracing member removably mounted to said structural assembly.

3. The livestock headgate of claim 2 wherein said structural assembly comprises an upright inside bar that resides at the inner edge of the gate panel, and the separate bracing member of each gate panel is removably mounted to said inside bar of the structural assembly.

4. The livestock headgate of claim 3 wherein said separating bracing member of each gate panel is channel-shaped over at least a partial length thereof for embraced fitting thereof over the upright inside bar at an inside face thereof that faces toward the other gate panel.

5. The livestock headgate of claim 4 wherein said separate bracing member of each gate panel has fastening holes in one or more channel side walls thereof for fastening of said separate channel-shaped bracing member to the inside bar of the structural assembly at one or both of the front and rear sides of the gate panel.

6. The livestock headgate of claim 4 wherein a central channel wall of the bracing member of each gate panel comprises a truncated end or cutout by which an open void is left in said bracing member to accommodate a yoke of the respective gate panel in protruding relation beyond the bracing surface.

7. The livestock headgate of claim 2 wherein said separate bracing member of each gate panel comprises a cutout region at which an open void is left in said separate bracing member to accommodate a yoke of the respective gate panel in protruding relation beyond the bracing surface.

8. The livestock headgate of claim 2 wherein said separate bracing member is configured for securement to the panel structure assembly at one or both of the front and rear sides of the gate panel.

9. An accessory for a livestock headgate that comprises a pair of gate panels that are movable toward one another into a closed position bracing a livestock animal between said gate panels in a central opening therebetween, are movable away from one another into an open position releasing said livestock animal from said central opening between said gate panels, and each have a front side, a rear side facing oppositely of said frontside, and an inner edge that is of neighbouring relation to the central opening and faces toward the inner edge of the other gate panel, said accessory comprising:
a pair of auxiliary bracing members each configured for removable attachment to a respective one of the gate panels at the inner edge thereof, and each comprising a respective angled bracing surface for abutting against a respective lateral side of a neck of the livestock animal in said closed position of the gate panels, said auxiliary bracing members being shaped such that, when mounted on the gate panels at the inner edges thereof, the angled bracing surfaces reside in convergent relation to one another in a forward direction moving toward the front sides of the gate panels from the rear sides thereof, so that said angled bracing surfaces are closer together at forward regions thereof nearest a head of the animal and further apart at rearward regions thereof further away from the head of the animal and nearer to shoulders thereof.

10. The accessory of claim 9 wherein each bracing member is channel shaped over at least a partial length thereof for embraced fitting thereof over the inner edge of the gate panel.

11. The accessory of claim 10 wherein each bracing member has fastening holes in one or more channel side walls thereof for fastening of said separate bracing member to the respective gate panel at one or both of the front and rear sides thereof.

12. The accessory of claim 10 wherein a central channel wall of each bracing member comprises a truncated end or cutout by which an open void is left in said bracing member to accommodate a yoke of the respective gate panel in protruding relation beyond the bracing surface.

13. The accessory of claim 9 wherein each bracing member comprises a cutout region at which an open void is left in said separate bracing member to accommodate a yoke of the respective gate panel in protruding relation beyond the bracing surface.

14. The livestock headgate of claim 9 wherein each bracing member is configured for securement to the panel structure assembly at one or both of the front and rear sides of the respective gate panel.
